(19) United States
(12) Patent Application Publication
(10) Pub. No.: US 2015/0270779 A1
(43) Pub. Date: Sep. 24, 2015

(54) DC-DC BOOST CONVERTER FOR POWER GENERATION ELEMENT

(71) Applicant: Electronics and Telecommunications Research Institute, Daejeon (KR)

(72) Inventors: Jong Pil IM, Suwon-si (KR); Kwi Dong KIM, Daejeon (KR); Tae Moon ROH, Daejeon (KR); Moon Gyu JANG, Daejeon (KR)

(21) Appl. No.: 14/453,436

(22) Filed: Aug. 6, 2014

(30) Foreign Application Priority Data
Mar. 18, 2014 (KR) 10-2014-0031720

(51) Int. Cl. H02M 3/158

(52) U.S. Cl. CPC H02M 3/158

(57) ABSTRACT

A DC-DC boost converter for a power generation element includes a power generation element configured to generate a both end voltage and a power supply current, an inductor charged by the power supply current, a first and second switch units comprising a plurality of first and second transistors, an MPPT control unit configured to detect the both end voltage and output a control signal to the first and second switch units so that an input voltage output from the power generation element is maintained as a predetermined proportion of the both end voltage, a current detection unit configured to output a signal for controlling the number of enabled first transistors and second transistors according to an intensity of the power supply current, and a switch selection unit configured to connect the first transistors and the second transistors through the signal.

### CROSS-REFERENCE TO RELATED APPLICATIONS

This U.S. non-provisional patent application claims priority under 35 U.S.C. §119 of Korean Patent Application No. 10-2014-0031720, filed on Mar. 18, 2014, the entire contents of which are hereby incorporated by reference.

### BACKGROUND OF THE INVENTION

The present invention disclosed herein relates to a DC-DC converter, and more particularly, to a DC-DC boost converter having a switch size control function.

A DC-DC converter is an electronic circuit device for converting a first voltage into a second voltage that is different from the first voltage. A transformer may be used to convert an AC voltage. However, the transformer is unable to directly convert a DC voltage. Therefore, the DC-DC converter converts a DC voltage into an AC voltage, and the obtained AC voltage is stepped up or stepped down using the transformer so that a DC voltage is output. However, during the converting process, power loss occurs in the DC-DC converter. The power loss of the DC-DC converter may be mainly caused by a transistor, an inductor, and a control unit.

In order to reduce the power loss of the DC-DC converter, a switch size control function may be provided. The switch size control function is a technology for controlling the number of enabled transistors so as to obtain high efficiency with respect to a load. To carry out the switch size control function, a current detection unit of the DC-DC converter detects an inductor current and applies the inductor current to a switch selection unit. The switch selection unit selects the number of transistors which minimizes the sum of switching loss and conduction loss of transistors, according to an intensity of the inductor current. Since the switch size is controlled according to the intensity of the inductor current, the efficiency of the DC-DC converter may be improved.

In a DC-DC buck converter, an intensity of a current that flows through an inductor is equal to that of a load current. The number of enabled transistors varies with the intensity of the load current.

Therefore, the load current should be detected in order to select the number of transistors. However, the load current is unable to be directly detected, but the inductor current may be detected. Therefore, the switch size control technology may be applied to the DC-DC buck converter in which the inductor current is equal to the load current. However, the switch size control technology may not be used for a DC-DC boost converter in which the inductor current is different from the load current.

### SUMMARY OF THE INVENTION

The present invention provides a switch-size-controllable DC-DC boost converter for boosting a voltage generated by a power generation element.

Embodiments of the present invention provide DC-DC boost converters for a power generation element, including a power generation element configured to generate a both end voltage and a power supply current, an inductor connected between a first node and a second node and charged by the power supply current, a first switch unit comprising a plurality of first transistors connected between the second node and a third node, a second switch unit comprising a plurality of second transistors connected to the second node and a ground terminal, a maximum power point tracking control unit configured to detect the both end voltage and output a control signal to the first and second switch unit so that an input voltage output from the power generation element is maintained as a predetermined proportion of the both end voltage, a current detection unit connected between the power generation element and the inductor and configured to output a signal for controlling the number of enabled first transistors of the first switch unit and the number of enabled second transistors of the second switch unit according to an intensity of the power supply current, and a switch selection unit configured to connect the first transistors of the first switch unit and the second transistors of the second switch unit through the signal.

In some embodiments, the maximum power point tracking control unit may turn off the first switch unit and turn on the second switch unit when the input voltage is higher than the predetermined proportion of the both end voltage, and may turn on the first switch unit and turn off the second switch unit when the input voltage is lower than the predetermined proportion of the both end voltage.

In other embodiments, when the first switch unit is turned off and the second switch unit is turned on, the inductor may be charged with energy by the power supply current, and, when the first switch is turned on and the second switch unit is turned off, a current generated by the energy charged in the inductor may be applied to the third node so as to be boosted.

In still other embodiments, the first and second switch units may include at least one converter configured to amplify a current of the control signal from the maximum power point tracking control unit, at least one transmission gate configured to receive the control signal of which the current has been amplified, and the first or second transistors connected to the at least one transmission gate.

In even other embodiments, the size of the first or second transistors may increase as the number of the first or second transistors increases, and the at least one inverter may be arranged between the first or second transistors.

In yet other embodiments, the at least one inverter may amplify the current of the control signal so that the first or second transistors are simultaneously turned on/off.

In further embodiments, one of the first and second switch units may include one transistor.

In still further embodiments, the current detection unit may select the number of the first and second transistors which minimizes a sum of switching loss and thermal conduction loss of the first and second transistors according to the intensity of the power supply current.

In even further embodiments, the switch selection unit may control the at least one transmission gate so that a transmission gate connected to the first and second transistors, among the at least one transmission gate, is selectively turned on, and the other transmission gates are turned off.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a DC-DC boost converter for a power generation element having a switch size control function, according to an embodiment of the present invention;

FIG. 2 is a circuit diagram illustrating the DC-DC boost converter for a power generation element having a switch size control function, according to the embodiment of the present invention; and

FIG. 3 is a circuit diagram illustrating a DC-DC boost converter for a power generation element having a switch size control function, according to a second embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. The same reference numerals refer to the same elements. Likewise, like reference numerals refer to like elements. The DC-DC boost converter for a power generation element described below and the operation performed thereby are merely examples, and thus may be variously modified without departing from the technical concept of the present invention.

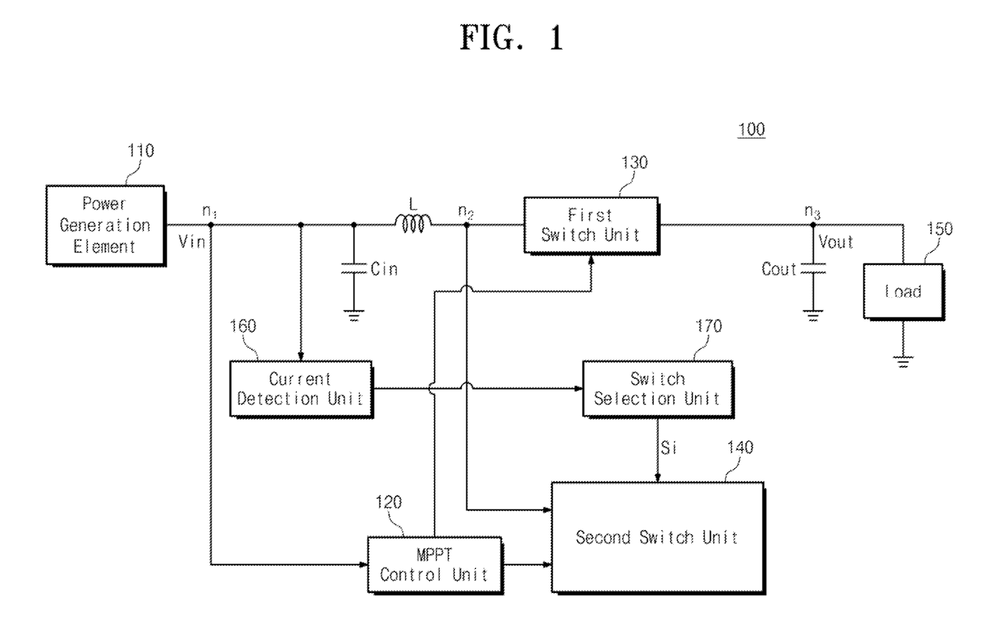

FIG. 1 is a block diagram illustrating a DC-DC boost converter for a power generation element having a switch size control function. Referring to FIG. 1, a DC-DC boost converter 100 for a power generation element includes a power generation element 110, a first capacitor Cin, an inductor L, a maximum power point tracking (MPPT) control unit 120, a first switch unit 130, a second switch unit 140, a second capacitor Cout, a load 150, a current detection unit 160, and a switch selection unit 170. The power generation element 110 may include a thermoelectric power generation element, but is not limited thereto.

The power generation element 110 of the present invention generates thermoelectric power by virtue of the Seebeck effect. In detail, the power generation element 110 has a structure in which two types of metals or both ends of a semiconductor are joined together. When a temperature difference between the metals or both ends occurs, a current and a both end voltage are generated, thereby generating thermoelectric power. The power generation element 110 applies an input voltage Vin and a power supply current generated by the both end voltage that varies with the temperature difference to the first capacitor Cin and the inductor L.

The first capacitor Cin may be arranged between a first node n1 and the inductor L. The first capacitor Cin may be included in the MPPT control unit 120 instead of being arranged between the first node n1 and the inductor L. The first capacitor Cin is charged by the input voltage Vin.

The inductor L may be arranged between the first node n1 and a second node n2. When the first switch unit 130 is turned off and the second switch unit 140 is turned on, the inductor L may be charged with energy by the power supply current and a current generated by the energy charged in the first capacitor Cin.

When the first switch unit 130 is turned on and the second switch unit 140 is turned off, the first capacitor Cin is charged by the power supply current. Furthermore, a current generated by the energy stored in the inductor L is applied to a third node n3. Therefore, a voltage on the third node n3 may be boosted to an output voltage Vout, and a desired current may be applied to the load 150. The first and second switch units 130 and 140 perform complementary operations.

The MPPT control unit 120 is connected to the first node n1. The MPPT control unit 120 generates control signals for turning on/off the first and second switch units 130 and 140. The MPPT control unit 120 controls the first and second switch units 130 and 140 so that the thermoelectric power generated by the power generation element 110 is maximally transferred to the load 150.

The first switch unit 130 is arranged between the second node n2 and the third node n3, and the second switch unit 140 is connected to the second node n2. The second capacitor Cout and the load 150 are connected to the third node n3.

For example, when the first switch unit 130 is turned on and the second switch unit 140 is turned off, the current generated by the energy charged in the inductor L charges the second capacitor Cout of the third node n3. Therefore, a voltage on the third node n3 may be boosted to the output voltage Vout, and a desired current may be applied to the load 150.

For example, when the first switch unit 130 is turned off and the second switch unit 140 is turned on, the second capacitor Cout applies the current generated by the energy stored therein to the load 150. Therefore, the output voltage Vout of the third node n3 is maintained constant.

The current detection unit 160 may be connected to the first node n1. The current detection unit 160 detects the power supply current that flows to the inductor L. The current detection unit 160 calculates a switching capacity of the second switch unit 140 which minimizes the sum of switching loss and thermal conduction loss according to an intensity of the detected power supply current. Therefore, when the intensity of the power supply current generated by the power generation element 110 is changed, the switching capacity of the second switch unit 140 is also changed. The current detection unit 160 applies information on the switching capacity of the second switch unit 140 to the switch selection unit 170.

The switch selection unit 170 receives the information on the switching capacity. The switch selection unit 170 controls the second switch unit 140 so that required switches are turned on and the other switches are turned off in the second switch unit 140.

A switch size control technology cannot be applied to a typical DC-DC boost converter, since an intensity of a current that flows through an inductor is different from that of a current that flows through a load and thus the load current cannot be detected. However, in the DC-DC boost converter 100 for a power generation element according to the present invention, the power supply current output from the power generation element 110 and the current input to the inductor L have the same intensity. Therefore, the switch size may be controlled by detecting the power supply current between the power generation element 110 and the inductor L. The switch size of the present invention is controlled by a current change due to a change of an output voltage. Therefore, the efficiency of the DC-DC boost converter 100 for a power generation element may be improved.

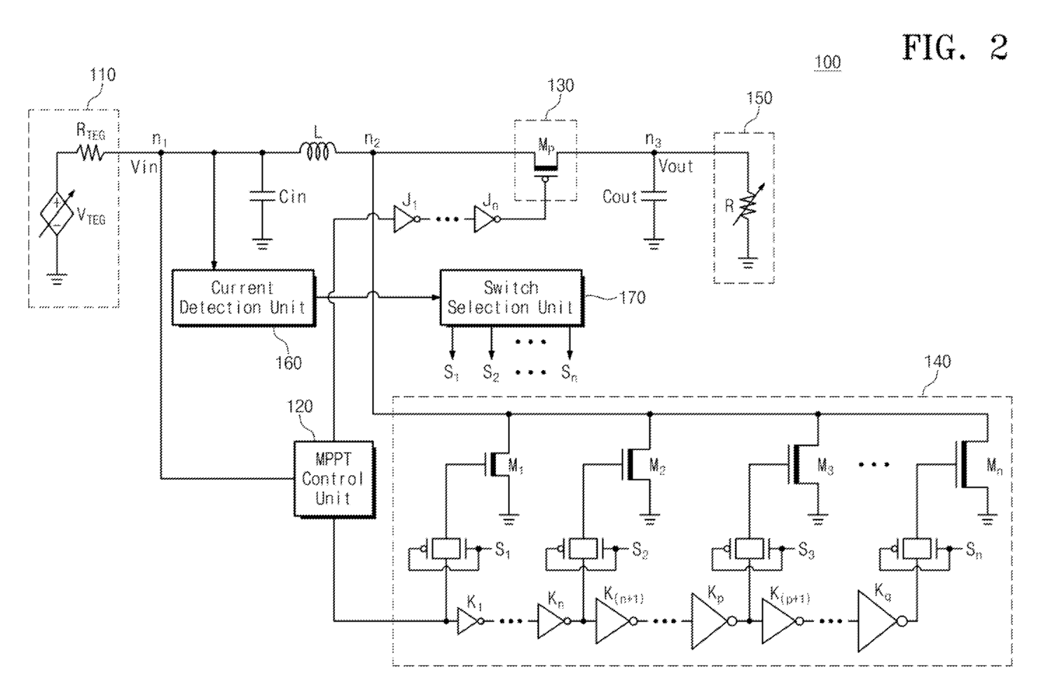

FIG. 2 is a circuit diagram illustrating a DC-DC boost converter for a power generation element having a transistor size control function. Referring to FIG. 2, due to a temperature change, a both end voltage Vteg and a resistance Rteg of the power generation element 110 are changed. The intensity of the power supply current output from the power generation element 110 also varies with the temperature change. The input voltage Vin and the power supply current according to the both end voltage Vteg are applied to the first capacitor Cin and the inductor L.

The MPPT control unit 120 is connected to the first node n1. The MPPT control unit 120 detects the both end voltage Vteg of the power generation element 110 and compares the both end voltage Vteg with the input voltage Vin generated due to the both end voltage Vteg. The MPPT control unit 120 generates the control signals for turning on/off the first and second switch units 130 and 140, according to a result of the comparison.

For example, if the input voltage Vin is higher than a predetermined proportion of the both end voltage Vteg, the MPPT control unit 120 controls the first and second switch units 130 and 140 so that the first switch unit 130 is turned off and the second switch unit 140 is turned on. If the input voltage Vin is lower than the predetermined proportion of the both end voltage Vteg, the MPPT control unit 120 controls the first and second switch units 130 and 140 so that the first switch unit 130 is turned on and the second switch unit 140 is turned off Here, the predetermined proportion represents a half of the both end voltage Vteg, but may be changed according to the type of the power generation element 110.

The first switch unit 130 may include a first PMOS transistor Mp and first to nth inverters J1 to Jn. A source terminal of the first PMOS transistor Mp is connected to the second node n2, and a drain terminal of the first PMOS transistor Mp is connected to the load 150. A gate terminal of the first PMOS transistor Mp is connected to the first to nth inverters J1 to Jn.

The first to nth inverters J1 to Jn are connected to the MPPT control unit 120 so as to serve as a gate driver. An intensity of a current of a control signal of the MPPT control unit 120 is very low. Therefore, it is difficult to turn on/off the first PMOS transistor Mp using the control signal of the MPPT control unit 120 alone. The first to nth inverters J1 to Jn receive the control signal from the MPPT control unit 120. The first to nth inverters J1 to Jn amplify the current of the control signal, and applies the control signal to the gate terminal of the first PMOS transistor Mp. The first PMOS transistor is turned on by the control signal of which the current has been amplified. Accordingly, the current generated by the energy stored in the inductor L is applied to the third node n3.

The second switch unit 140 includes first to nth NMOS transistors M1 to Mn, first to nth transmission gates S1 to Sn, and first to qth inverters K1 to Kq. Drain terminals of the first to nth NMOS transistors M1 to Mn are connected to the second node n2, and source terminals of the first to nth NMOS transistors M1 to Mn are grounded. Gate terminals of the first to nth NMOS transistors M1 to Mn are connected to the first to nth transmission gates S1 to Sn. As the number of transistors increases, the transistor size increases. At least one of the first to qth inverters K1 to Kq may be connected between the first to nth transmission gates S1 to Sn so as to serve as a gate driver.

The first to qth inverters K1 to Kq are connected to the MPPT control unit 120. As the number of inverters increases, the inverter size increases. If the transistor size is small, transistors may be rapidly turned on/off using the control signal output from the MPPT control unit 120 alone. However, the transistor size becomes larger as the number of transistors increases from the first NMOS transistor M1 to the nth NMOS transistor Mn. Therefore, the intensity of the current of the control signal input to the first to nth NMOS transistors Ml to Mn may need to be increased so as to rapidly turn on/off the transistors. Therefore, the first to qth inverters K1 to Kq amplify the current of the control signal output from the MPPT control unit 120.

As the number and size of transistors increase, the number of inverters connected between the transistors increases. Since the first to qth inverters K1 to Kq amplify the current of the control signal, the first to nth transistors Ml to Mn may be simultaneously turned on/off. The number of the inverters connected between the transistors may be changed according to the transistor size.

If the input voltage Vin is higher than the predetermined proportion of the both end voltage Vteg, the first switch unit 130 is turned off and the second switch unit 140 is turned on. A current output from the first capacitor Cin charged by the power supply current is input to the inductor L. Since the inductor L is charged by the current output from the first capacitor Cin, the input voltage Vin becomes lower than the predetermined proportion of the both end voltage Vteg.

When the input voltage Vin is lower than the predetermined proportion of the both end voltage Vteg, the first switch unit 130 is turned on and the second switch unit 140 is turned off. Accordingly, the first capacitor Cin is charged by the power supply current, and the input voltage Vin becomes higher than the predetermined proportion of the both end voltage Vteg. When the input voltage Vin is higher than the predetermined proportion of the both end voltage Vteg, the first switch unit 130 is turned off and the second switch unit 140 is turned on again. Through the above-mentioned feedback process, the input voltage Vin may be maintained as the predetermined proportion of the both end voltage Vteg, and maximum power may be applied to the load 150.

The current detection unit 160 is arranged between the first node n1 and the first capacitor Cin. The current detection unit 160 detects the power supply current that flows to the inverters. The power generation element 110 outputs the power supply current that is proportional to a temperature change. Therefore, the current detection unit 160 detects the changed intensity of the power supply current so as to calculate the number of the first to nth NMOS transistors M1 to Mn which reduces the power loss of the DC-DC boost converter 100 for a power generation element. In detail, the current detection unit 160 includes information on the number of transistors which minimizes the sum of the switching loss and thermal conduction loss of the transistors according to the intensity of the power supply current. The current detection unit 160 applies information on the number of required transistors to the switch selection unit 170.

The switch selection unit 170 receives the information on the number of transistors which reduces the power loss. The switch selection unit 170 controls the first to nth transmission gates S1 to Sn connected to the first to nth transistors M1 to Mn so that the first to nth transmission gates S1 to Sn are selectively turned on. In this case, the switch selection unit 170 controls the first to nth transmission gates S1 to Sn so that unselected transmission gates are turned off.

For example, when a current that is smaller than a first current I1 flows through the inductor, the switch selection unit 170 controls the first to nth transmission gates S1 to Sn so that the first transmission gate S1 connected to the first NMOS transistor M1 is turned on and the second to nth transmission gates S2 to Sn are turned off.

For example, when a current that is greater than the first current I1 and smaller than a second current I2 flows through the inductor, the switch selection unit 170 controls the first to nth transmission gates S1 to Sn so that the first and second transmission gates S1 and S2 connected to the first and second NMOS transistors M1 and M2 are turned on and the third to nth transmission gates S3 to Sn are turned off.

Using such a switch size control function, the power loss of transistors may be reduced. Furthermore, the efficiency of the DC-DC boost converter for a power generation element may be improved.

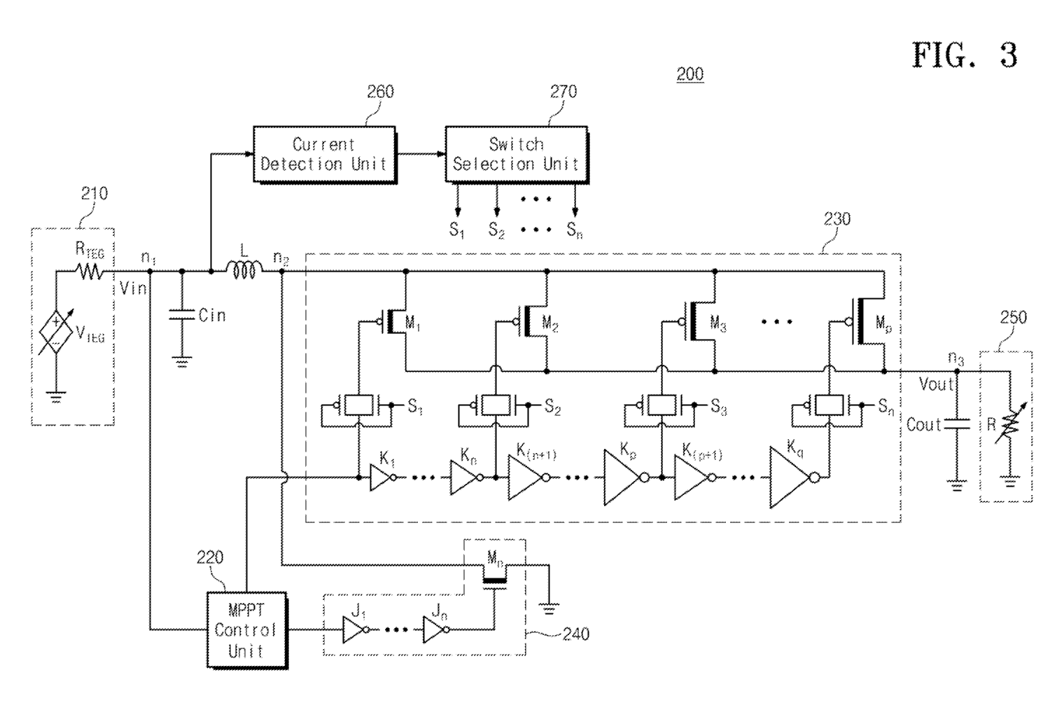

FIG. 3 is a circuit diagram illustrating a DC-DC boost converter for a power generation element having a switch size control function according to a second embodiment of the present invention. Referring to FIG. 3, a DC-DC boost converter 200 for a power generation element includes a power generation element 210, a first capacitor Cin, an inductor L, an MPPT control unit 220, a first switch unit 230, a second switch unit 240, a second capacitor Cout, a load 250, a current detection unit 260, and a switch selection unit 270. The DC-DC boost converter 200 for a power generation element of FIG. 3 is similar to the DC-DC boost converter 100 for a power generation element of FIG. 2. However, the switch size control function is carried out by the first switch unit 230 in the DC-DC boost converter 200 for a power generation element of FIG. 3.

As described above with respect to the DC-DC boost converter 100 for a power generation element of FIG. 2, the power generation element 210 generates a both end voltage Vteg varying with a temperature change, and outputs a power supply current. An input voltage Vin generated by the both end voltage Vteg is applied to the MPPT control unit 220 through a first node n1.

The MPPT control unit 220 detects the both end voltage Vteg generated in the power generation element 210 and compares the both end voltage Vteg with the input voltage Vin generated due to the both end voltage Vteg. The MPPT control unit 220 controls turning on/off operations of the first and second switch units 230 and 240 so that the input voltage Vin is maintained as a predetermined proportion of the both end voltage Vteg.

For example, if the input voltage Vin is higher than the predetermined proportion of the both end voltage Vteg, the MPPT control unit 220 controls the first and second switch units 230 and 240 so that the first switch unit 230 is turned off and the second switch unit 240 is turned on. If the input voltage Vin is lower than the predetermined proportion of the both end voltage Vteg, the MPPT control unit 220 controls the first and second switch units 230 and 240 so that the first switch unit 230 is turned on and the second switch unit 240 is turned off.

The first switch unit 230 includes first to pth PMOS transistors M1 to Mp, first to nth transmission gates S1 to Sn, and first to qth inverters K1 to Kq. Source terminals of the first to pth PMOS transistors M1 to Mp are connected to a second node n2, and drain terminals of the first to pth PMOS transistors M1 to Mp are connected to a third node n3. Gate terminals of the first to pth PMOS transistors M1 to Mp are connected to the first to nth transmission gates S1 to Sn. The PMOS transistor size increases as the number of transistors increases from the first PMOS transistor M1 to the pth PMOS transistor Mp.

At least one inverter exists between the first to nth transmission gates S1 to Sn. The first to qth inverters K1 to Kq are connected to the MPPT control unit 220. The MPPT control unit 220 applies a control signal for turning on/off the first switch unit 230 to the first to qth inverters K1 to Kq. As described above with reference to FIG. 2, at least one inverter is provided to amplify the current of the control signal. As the PMOS transistor size increases, the current of the control signal may need to be increased to rapidly turn on/off transistors.

Therefore, at least one inverter is inserted between the first to pth PMOS transistors M1 to Mp so that the first to pth PMOS transistors M1 to Mp are simultaneously turned on/off. The inverter size increases as the number of inverters increases from the first inverter K1 to the qth inverter Kq. The number of the inverters connected between the transistors is changed according to the transistor size.

The second switch unit 240 includes a first NMOS transistor Mn. A drain terminal of the first NMOS transistor Mn is connected to the second node n2, and a source terminal of the first NMOS transistor Mn is grounded. A gate terminal of the first NMOS transistor Mn is connected to first to nth inverters J1 to Jn so as to serve as a gate driver. The first to nth inverters J1 to Jn are connected to the MPPT control unit 220.

As described above with reference to FIG. 2, the first to nth inverters J1 to Jn receive the control signal from the MPPT control unit 220, and amplify the current of the control signal. Therefore, the first to nth inverters J1 to Jn apply, to the first NMOS transistor Mn, the control signal of which the current has been amplified. A voltage on the third node n3 is boosted according to the turning on/off operations of the first and second switch units 230 and 240 in a similar manner to that of the DC-DC boost converter 100 for a power generation element of FIG. 2.

The current detection unit 260 may be connected to the first node n1. The current detection unit 260 detects the intensity of the power supply current. The current detection unit 260 selects the number of PMOS transistors which reduces the loss of the switch unit according to the intensity of the power supply current. The current detection unit 260 calculates the number of PMOS transistors which minimizes the sum of the switching loss and thermal conduction loss of the switch unit according to the intensity of the power supply current, and applies information on a result of the calculation to the switch selection unit 270.

The switch selection unit 270 controls the first to nth transmission gates S1 to Sn connected to the first to pth transistors M1 to Mp so that the first to nth transmission gates S1 to Sn are selectively turned on.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A DC-DC boost converter for a power generation element, comprising:
a power generation element configured to generate a both end voltage and a power supply current;
an inductor connected between a first node and a second node and charged by the power supply current;
a first switch unit comprising a plurality of first transistors connected between the second node and a third node;
a second switch unit comprising a plurality of second transistors connected to the second node and a ground terminal;
a maximum power point tracking control unit configured to detect the both end voltage and output a control signal to the first and second switch units so that an input voltage output from the power generation element is maintained as a predetermined proportion of the both end voltage;
a current detection unit connected between the power generation element and the inductor and configured to output a signal for controlling the number of enabled first transistors of the first switch unit and the number of enabled second transistors of the second switch unit according to an intensity of the power supply current; and
a switch selection unit configured to connect the first transistors of the first switch unit and the second transistors of the second switch unit through the signal.

2. The DC-DC boost converter of claim 1, wherein the maximum power point tracking control unit turns off the first switch unit and turns on the second switch unit when the input voltage is higher than the predetermined proportion of the both end voltage, and turns on the first switch unit and turns off the second switch unit when the input voltage is lower than the predetermined proportion of the both end voltage.

3. The DC-DC boost converter of claim 1, wherein, when the first switch unit is turned off and the second switch unit is turned on, the inductor is charged with energy by the power supply current, and, when the first switch is turned on and the second switch unit is turned off, a current generated by the energy charged in the inductor is applied to the third node so as to be boosted.

4. The DC-DC boost converter of claim 1, wherein the first and second switch units comprise:
at least one converter configured to amplify a current of the control signal from the maximum power point tracking control unit;
at least one transmission gate configured to receive the control signal of which the current has been amplified; and
the first or second transistors connected to the at least one transmission gate.

5. The DC-DC boost converter of claim 4, wherein the size of the first or second transistors increases as the number of the first or second transistors increases, and the at least one inverter is arranged between the first or second transistors.

6. The DC-DC boost converter of claim 4, wherein the at least one inverter amplifies the current of the control signal so that the first or second transistors are simultaneously turned on/off.

7. The DC-DC boost converter of claim 1, wherein one of the first and second switch units comprises one transistor.

8. The DC-DC boost converter of claim 1, wherein the current detection unit selects the number of the first and second transistors which minimizes a sum of switching loss and thermal conduction loss of the first and second transistors according to the intensity of the power supply current.

9. The DC-DC boost converter of claim 1, wherein the switch selection unit controls the at least one transmission gate so that a transmission gate connected to the first and second transistors, among the at least one transmission gate, is selectively turned on, and the other transmission gates are turned off.
